(19) United States
(12) Patent Application Publication
(10) Pub. No.: US 2016/0164881 A1
(43) Pub. Date: Jun. 9, 2016

(54) REMOTE VEHICLE APPLICATION PERMISSION CONTROL AND MONITORING

(71) Applicant: Ford Global Technologies, LLC, Dearborn, MI (US)

(72) Inventors: Stefan BANKOWSKI, Royal Oak, MI (US); Michael Raymond WESTRA, Plymouth, MI (US); David Chase MITCHELL, Dearborn, MI (US); Julius MARCHWICKI, Detroit, MI (US); Elizabeth HALASH, Warren, MI (US)

(21) Appl. No.: 14/559,582

(22) Filed: Dec. 3, 2014

(51) Int. Cl. H04L 29/06; H04L 12/26

(52) U.S. Cl. CPC H04L 63/105; H04L 43/08

(57) ABSTRACT

A vehicle may identify an application identifier of a mobile application executed by a mobile device paired with the vehicle; query a local policy table for application permissions associated with the application identifier, the application permissions defining which user interface features, vehicle information elements, and vehicle functions are accessible to the mobile application; and provide the mobile application with vehicle access in accordance with the application permissions. The vehicle may also identify the application permissions additionally according to a mobile device identifier of the mobile device paired with the vehicle. A mobile device paired with the vehicle may send, to a vehicle, a policy table update received from a server and including a local policy table including application permissions defining which user interface features, information elements, and functions of the vehicle are accessible to a mobile application; and execute the mobile application in accordance with the application permissions.

### TECHNICAL FIELD

Aspects of this disclosure relate to control and monitoring of application permissions for vehicle applications.

### BACKGROUND

A voice control system for a vehicle may allow for third party applications to integrate voice commands into their system. By doing so, the third party applications may be controllable via the voice interface of the vehicle. However, some third party applications may not be suitable for use when the vehicle is in motion, or may be restricted according to government regulations. Moreover, some third party applications may attempt to retrieve information unnecessary for application operation, causing potential user privacy concerns.

### SUMMARY

In a first illustrative embodiment, a system includes a processor of a vehicle configured to identify an application identifier of a mobile application executed by a mobile device paired with the vehicle, query a local policy table for application permissions associated with the application identifier, the application permissions defining which user interface features and vehicle information elements are accessible to the mobile application, and provide the mobile application with vehicle access in accordance with the retrieved application permissions.

In a second illustrative embodiment, a system includes a mobile device paired with a vehicle and configured to send, to a vehicle, a policy table update received from a server and including a local policy table including application permissions defining which user interface features, information elements, and functions of the vehicle are accessible to a mobile application; and execute the mobile application in accordance with the application permissions.

In a third illustrative embodiment, an application remote management server is configured to receive, from a vehicle, an application usage update message including a local policy table having application identifiers of mobile applications available to the vehicle from a paired mobile device; and send, to the vehicle, a local policy table including application permissions defining which user interface features, information elements, and functions of the vehicle are accessible to the mobile applications.

### BRIEF DESCRIPTION OF THE DRAWINGS

FIG. 1 illustrates an example vehicle computing system;

FIG. 2 illustrates an example application policies architecture;

FIG. 3 illustrates an example user interface of the vehicle computing system from which approval to utilize mobile applications may be selected;

FIG. 4A illustrates an example user interface of the vehicle computing system from which mobile application settings may be configured;

FIG. 4B illustrates an alternate view of an example user interface of the vehicle computing system from which mobile application settings may be configured;

FIG. 5 illustrates an example user interface of the vehicle computing system for granting permissions specified by the local policy table to a mobile application;

FIG. 6 illustrates an example user interface of an application remote management system;

FIG. 7 illustrates an example process for updating a master policy table;

FIG. 8 illustrates an example process for updating a local policy table of the vehicle; and

FIG. 9 illustrates an example process for using a local policy table for permission control for mobile applications.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

An application remote management and reporting server may be configured to provide remote application permission control for connected vehicle telematics applications installed to a user's paired mobile device. This may allow for remote configuration, by the server, of which applications and/or which paired mobile devices have permission to access vehicle systems. For those applications and devices that have permission, the system may further provide for configuration of what features or vehicle functions the applications or devices can access. The system may further be configured to cause the vehicle to secure user consent and user notification before allowing use of the connected applications.

The server may include an administrative interface (e.g., a secure web interface) that allows an administrative user to input application information and define functionality and other operation of the system. The server may also include an interface to the vehicle that allows a policy table file to be passed between the server and vehicle. The policy table file may include information detailing application permissions in the vehicle and information describing how and when the vehicle should request permission updates. Additionally, the vehicle may be configured to write usage information to the policy table file to return to the server for reporting purposes.

The policy table file may be passed between the server and the vehicle via the user's mobile device that is paired with the vehicle and executing the vehicle applications. In an example, the file may be transferred to the vehicle via the mobile device, by way of a response to a hypertext transport protocol (HTTP) request to a universal resource locator (URL) of the server associated with provisioning of vehicle application policies. In an example, the URL may be included in the policy table file. The policy table file may be encrypted and signed by the vehicle key to mitigate the possibility of man-in-the-middle attackers intercepting the data.

Each connected vehicle telematics applications installed to a user's paired mobile device may be associated with an application identifier (e.g., provided from the vehicle manufacturer or other identifier management authority). In an example, a management user having access to the administrative interface of the server may input the application's information, including allowed APIs and permissions, and may generate an application identifier for the requesting application.

When the application registers in-vehicle with the vehicle computing system, the application passes along the application identifier. The vehicle computing system may then check the local policy table file for the application policy associated with the provided application identifier. In some cases, the system may support device-specific permissions, and the vehicle computing system may check the local policy table file for the application policy associated with the provided application identifier and device identifier.

The application policy may dictate whether the application is allowed to run in the vehicle, and if so, which vehicle functions whose permission is controlled may be accessed by the application. If the policy table file does not contain policy permissions for the application identifier, the vehicle computing system may request a policy table file update from the server. The policy table file update request may include the current policy table file of the vehicle as well as the unknown application identifier. The policy table file update request may also include recorded application usage indicative of mobile application usage of the vehicle functions whose permission is controlled by the policy table file. The updated policy table file provided by the server may include updated policy permissions, including a policy for the newly registered application. Further aspects of the remote configuration and reporting of connected application features are discussed in detail below.

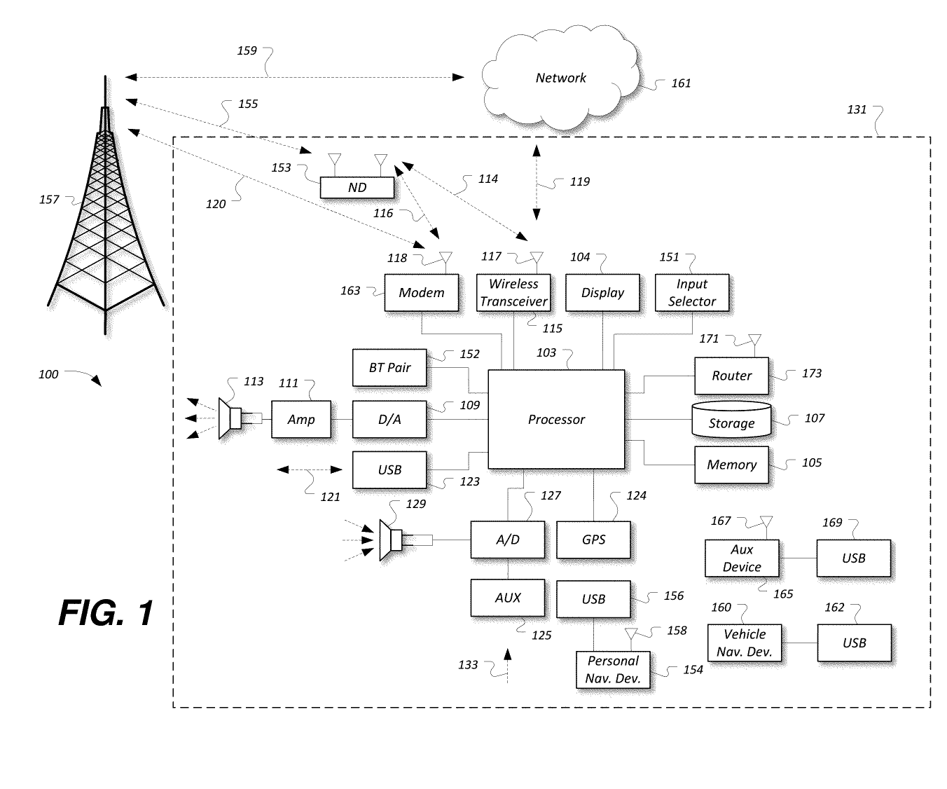

FIG. 1 illustrates an example block topology for a vehicle based computing system 100 (VCS) for a vehicle 131. An example of such a VCS 100 is the SYNC system manufactured by THE FORD MOTOR COMPANY. A vehicle 131 enabled with a VCS 100 may contain a visual front end interface 104 located in the vehicle 131. The user may also be able to interact with the interface 104 if it is provided, for example, with a touch sensitive screen. In another illustrative embodiment, the interaction occurs through, button presses, spoken dialog system with automatic speech recognition and speech synthesis. As a further possibility, interaction with the vehicle 131 may be implied by a nomadic device 153 or an application installed to the nomadic device 153 connecting to the VCS 100.

In the illustrative VCS 100 shown in FIG. 1, a processor 103 (e.g., a CPU, an application microprocessor, a modem processor, etc.) controls at least some portion of the operation of the VCS 100. Provided within the vehicle 131, the processor 103 allows onboard processing of commands and routines. Further, the processor 103 is connected to both non-persistent memory 105 and persistent storage 107. In this illustrative embodiment, the non-persistent memory 105 is random access memory (RAM) and the persistent storage 107 is a hard disk drive (HDD) or a flash memory. In general, persistent (non-transitory) storage 107 can include all forms of storage that maintain data when a computer or other device is powered down. These include, but are not limited to, HDDs, compact disks (CDs), digital versatile disks (DVDs), magnetic tapes, solid state drives (SSDs), portable universal serial bus (USB) drives and any other suitable form of persistent storage.

The processor 103 is also provided with a number of different inputs allowing the user to interface with the processor 103. In this illustrative embodiment, a microphone 129, an auxiliary input 125 (for input 133), a USB input 123, a GPS input 124, the front end interface 104 (which may include a touchscreen display), and a wireless transceiver 115 (such as a BLUETOOTH input) are all provided. An input selector 151 is also provided, to allow a user to swap between various inputs. Input to both the microphone 129 and the auxiliary input 125 may be converted from analog to digital by a converter 127 before being passed to the processor 103. Although not shown, numerous of the vehicle 131 components and auxiliary components in communication with the VCS 100 may use a network (such as, but not limited to, a controller area network (CAN) bus) of the vehicle 131 to pass data to and from the VCS 100 (or components thereof).

Outputs to the system can include, but are not limited to, a visual display 104 and a speaker 113 or audio system output. The speaker 113 is connected to an amplifier 111 and receives its signal from the processor 103 through a digital-to-analog converter 109. Output can also be made to a remote BLUETOOTH device such as a personal navigation device (PND) 154 or a USB device such as vehicle navigation device 160 along the bi-directional data streams shown at 119 and 121 respectively.

In one illustrative embodiment, the system 100 uses the wireless transceiver 115 to communicate 117 with a nomadic device (ND) 153 of a user (e.g., a cellular phone, a smart phone, a personal digital assistant (PDA), or any other mobile device having wireless remote network connectivity). The nomadic device 153 can then be used to communicate 159 with a network 161 outside the vehicle 131 through, for example, communication 155 with a cellular tower 157. In some embodiments, tower 157 may be a WiFi access point. Exemplary communication between the nomadic device 153 and the wireless transceiver 115 is represented by connection 114. Using the paired nomadic device 153, data may be communicated between the processor 103 and network 161 over the connection 114 utilizing, for example, a data-plan, data over voice, or DTMF tones associated with nomadic device 153.

Pairing a nomadic device 153 and the wireless transceiver 115 can be instructed through a button 152 or similar input. Accordingly, the processor 103 is instructed that the wireless transceiver 115 of the VCS 100 will be paired with a wireless transceiver in a nomadic device 153 (e.g., a BLUETOOTH transceiver integrated with the nomadic device 153, not shown).

Additionally or alternatively, the VCS 100 may include an onboard modem 163 having an antenna 118 configured to communicate 116 data between the processor 103 and the network 161. This communication may be performed over a data band and/or over a data channel. The nomadic device 153 can then be used to communicate 159 with the network 161 outside of the vehicle 131 through, for example, communication 155 with a cellular tower 157. In some embodiments, the modem 163 may establish communication 120 with the tower 157 for communicating with network 161. As a non-limiting example, the modem 163 may be a USB cellular modem 163 and communication 120 may be by way of a cellular communication protocol.

In one illustrative embodiment, the processor 103 is provided with an operating system including an application programming interface (API) to communicate with modem application software. The modem application software may access an embedded module or firmware on the wireless transceiver 115 to complete wireless communication with a remote wireless transceiver (such as that found in a nomadic device 153). BLUETOOTH is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle 131. Another communication means that can be used in this realm is free-space optical communication (such as IrDA) and non-standardized consumer infrared (IR) protocols.

In another embodiment, nomadic device 153 includes a modem for voice band or broadband data communication. In the data-over-voice embodiment, a technique known as frequency division multiplexing may be implemented when the owner of the nomadic device 153 can talk over the nomadic device 153 while data is being transferred. At other times, when the owner is not using the device, the data transfer can use the whole bandwidth (300 hertz (Hz) to 3.4 kilohertz (kHz) in one example). While frequency division multiplexing may be common for analog cellular communication between the vehicle 131 and the Internet, and is still used, it has been largely replaced by hybrids of Code Division Multiple Access (CDMA), Time Division Multiple Access (TDMA), Space-Division Multiple Access (SDMA) for digital cellular communication. These are all ITU IMT-2000 (3G) compliant standards and offer data rates up to two megabits per second (mbs) for stationary or walking users and 385 kilobits per second (kbs) for users in a moving vehicle 131. 3G standards are now being replaced by IMT-Advanced (4G) which offers 100 mbs for users in a vehicle 131 and one gigabit per second (gbs) for stationary users. If the user has a data-plan associated with the nomadic device 153, it is possible that the data-plan allows for broad-band transmission and the system could use a much wider bandwidth (speeding up data transfer). In still another embodiment, nomadic device 153 is replaced with a cellular communication device (not shown) that is installed to vehicle 131. In yet another embodiment, the nomadic device 153 may be a wireless local area network (LAN) device capable of communication over, for example (and without limitation), an 802.11g network (i.e., WiFi) or a WiMax network.

In one embodiment, incoming data can be passed through the nomadic device 153 via a data-over-voice or data-plan, through the onboard BLUETOOTH transceiver and into the internal processor 103 of the vehicle 131. In the case of certain temporary data, for example, the data can be stored on the HDD or other persistent storage 107 until such time as the data is no longer needed.

Additional sources that may interface with the vehicle 131 include a PND 154, having, for example, a USB connection 156 and/or an antenna 158, a vehicle navigation device 160 having a USB 162 or other connection, an onboard GPS device 124, or remote navigation system (not shown) having connectivity to network 161. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the processor 103 could be in communication with a variety of other auxiliary devices 165. These auxiliary devices 165 can be connected through a wireless 167 or wired 169 connection. Auxiliary device 165 may include, but are not limited to, personal media players, wireless health devices, portable computers, and the like.

Also, or alternatively, the processor 103 could be connected to a vehicle-based wireless router 173, using for example a WiFi (IEEE 803.11) 171 transceiver. This could allow the processor 103 to connect to remote networks in range of the local router 173.

In addition to having exemplary processes executed by a VCS 100 located in a vehicle 131, in certain embodiments, the exemplary processes may be executed by a computing system in communication with a VCS 100. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor 103 to perform the process. All processes need not be performed in their entirety, and are understood to be examples of types of processes that may be performed to achieve elements of the invention. Additional steps may be added or removed from the exemplary processes as desired.

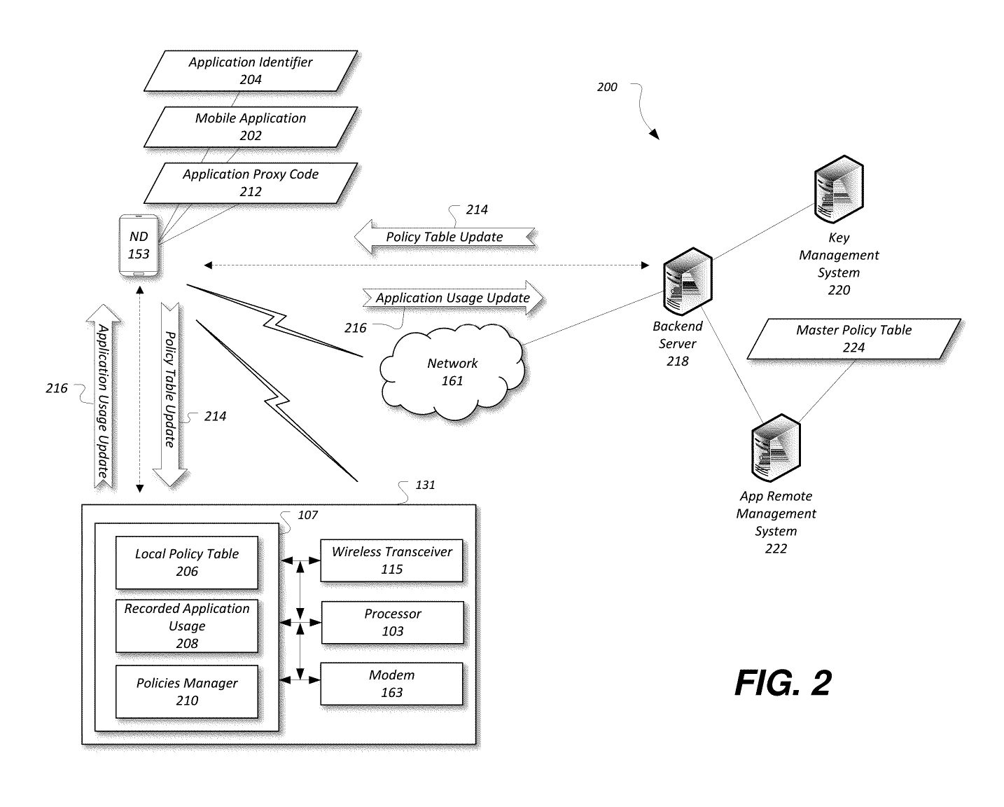

FIG. 2 illustrates an example application policies architecture 200. As illustrated, the architecture 200 includes a vehicle 131 having a policies manager 210 in communication with a backend server 218 via the network 161. The policies manager 210 may be configured to maintain a local policy table 206 and recorded application usage 208. The nomadic device 153 may execute a mobile application 202 associated with an application identifier 204 and including application proxy code 212 facilitating communication with the backend server 218 by way of the network 161. The backend server 218 may be configured to provide access to a key management system 220 and an application remote management system 222 maintaining a master policy table 224. As explained in detail below, the remote management system 222 may be configured to provide policy table updates 214 to the vehicle 131 via the application proxy code 212 of the nomadic device 153.

The mobile application 202 may be an application installed to the nomadic device 153 for use with the VCS 100 of the vehicle 131. In an example, the mobile application 202 may add functionality to the VCS 100 by integrating voice commands controlling the functionality of the mobile application 202 with a voice command interface of the VCS 100. The mobile application 202 may be further configured to utilize user interface features of the VCS 100, such as the visual display 104 or the speaker 113, to provide information to vehicle occupants.

The application identifier 204 may be a unique number or alphanumeric string assigned to a mobile application 202. In some cases, the application identifier 204 may be randomly generated value. In other cases, the application identifier 204 may be assigned to the mobile application 202 by an authority configured to manage the application identifiers 204.

The local policy table 206 may be configured to store key information detailing application permissions in the vehicle 131. Thus, the local policy table 206 may define the type of interaction that is allowed between the VCS 100 and a given mobile application 202. In an example, the local policy table 206 may include permission information for the mobile applications 202 keyed according to the application identifiers 204 assigned to the mobile applications 202. The permission information may include, for example, a listing of APIs and vehicle 131 systems that are deemed allowable for use by the mobile applications 202. As some specific examples, the local policy table 206 may include permission information with respect to remote procedure calls of the VCS 100 that are allowable for access by the mobile application 202, such as to stream audio or to retrieve a current GPS location of the vehicle 131. As some other examples, the local policy table 206 may include permission information with respect whether the mobile application 202 has permission to perform a context switch and take focus from another application, e.g., to interrupt the radio to provide a message. As yet a further example, the local policy table 206 may include permission information with respect whether the mobile application 202 may execute scripts on the VCS 100. As an even a further example, the local policy table 206 may include permission information with respect to which vehicle 131 functions may be utilized when the vehicle 131 is parked or stationary, and which may be used when the vehicle 131 is in motion. The local policy table 206 may also include information to configure how and when the vehicle 131 requests updates to the local policy table 206, as well as information regarding how to contact a source of updated local policy tables 206 (e.g., a URL or other address of the backend server 218).

In some examples, the local policy table 206 may include different sets of application permissions keyed to different nomadic devices 153. As one possibility, the local policy table 206 may include application permissions keyed to mobile device identifier (e.g., mobile device number, pairing information, etc.). As another possibility, the vehicle 131 may maintain different local policy tables 206 for each mobile device identifier of a nomadic device 153 paired to the VCS 100. As yet a further possibility, the permissions keyed to mobile device identifier may include permissions for the use of the nomadic device 153 regardless of application. In an example, the local policy table 206 may include permissions for use of phone remoting features, such as ability to use display 104 or another vehicle 131 display to display video or other content from the user's nomadic device 153.

The recorded application usage 208 may include logged usage of the API and vehicle 131 system usage, or other vehicle 131 functions whose permission is controlled for the mobile applications 202. Thus, the recorded application usage 208 may include collected usage data regarding how users are using the mobile applications 202 in the vehicle 131. As with the local policy table 206, the recorded application usage 208 may be keyed according to the application identifiers 204 assigned to the mobile applications 202. In some examples, the recorded application usage 208 may be included within the local policy table 206, while in other examples the recorded application usage 208 may be maintained separate from the local policy table 206. As some specific examples of logged information, the recorded application usage 208 may include run attempts of the mobile application 202, errors experienced by the mobile application 202 (e.g., permission denied errors, unexpected errors such as those due to programming errors, etc.), logged HMI usage information (e.g., steering wheel control usage, voice command usage, etc.), and audible time during which the mobile application 202 provided audio through the vehicle 131 HMI.

The policies manager 210 may be configured to manage mobile application 202 permissions for the VCS 100 of the vehicle 131. In an example, the policies manager 210 may maintain the local policy table 206. When a mobile application 202 is initiated or activated, the policies manager 210 may identify the permissions associated with a mobile application 202 based on the local policy table 206. Moreover, when the mobile application 202 interacts with the VCS 100, the policies manager 210 may record the mobile application 202 usage of vehicle APIs and vehicle 131 systems in the recorded application usage 208.

The policies manager 210 of the VCS 100 may be further configured to manage communication to the backend server 218. In terms of requests or responses between the policies manager 210 and the backed server 218, the policies manager 210 may be configured to initiate communications to the backend server 218. In an example, the policies manager 210 may provide a message to the backend server 218 to inform the backend server 218 that the vehicle 131 is on and listening for information. In some cases, the backend server 218 may address an unsolicited message to a specific vehicle 131 and push it to the cloud. However, the message may not be delivered to the vehicle 131 until the VCS 100 connects and requests it from the backend server 218.

The policies manager 210 may be configured to request the backend server 218 to provide the vehicle 131 with updates to the local policy table 206. For instance, the policies manager 210 may request an update to the local policy table 206 if a mobile application 202 having an application identifier 204 not in the local policy table 206 attempts to integrate with the VCS 100 of the vehicle.

The policies manager 210 may be further configured to provide the recorded application usage 208 to the backend server 218 for remote review and processing. To do so, the policies manager 210 may provide an application usage update 216 message including the recorded application usage 208 information stored by the vehicle 131. This may allow the system to verify that the mobile application 202 is utilizing the APIs and vehicle 131 systems appropriately, given the apparent purpose of the mobile application 202. For instance, it may be reasonable for a navigation mobile application 202 to periodically request speed information for the vehicle 131, but it may be unreasonable for an internet radio mobile application 202 to do so.

The application proxy code 212 may be configured to facilitate the communication of the policies manager 210 with the backend server 218. In an example, the application proxy code 212 may include a library or other code module compiled or linked into the mobile applications 202 and providing functionality to allow the policies manager 210 to communicate through the mobile applications 202 to the backend server 218. The policies manager 210 may accordingly utilize the application proxy code 212 to request policy table updates 214 via the backend server 218, provide application usage updates 216 to the backend server 218, and receive policy table updates 214 from the backend server 218. The policy table updates 214 may include, for example, a new local policy table 206 to replace the local policy table 206 currently stored by the policies manager 210, or updates to an existing local policy table 206 to augment the current entries of the local policy table 206. The application proxy code 212 may further include other functionality that may be useful for communication with the backend server 218, such as the ability to pass encrypted messages between the VCS 100 and the backend server 218.

The wireless transceiver 115 of the vehicle 131 may be connected to a paired nomadic device 153 (e.g. via a BLUETOOTH connection, via a USB connection, etc.), such that the communications features of the nomadic device 153 may be used to allow the VCS 100 to communicate via the network 161 with the backend server 218. The network 161 may accordingly be utilized by the nomadic device 153 via a cellular data plan of the nomadic device 153 (e.g., to provide TCP/IP-based communications functionality to the VCS 100. Additionally or alternately, the VCS 100 may include an onboard modem 163 configured to communicate 116 data between the processor 103 and the network 161. Messages directed to the vehicle 131 via the network 161 may be queued in the cloud until a connection to the vehicle 131 can be established or until the message expires. In an example, the queuing and message expiration functionality may be implemented via the backend server 218. The network 161 message queuing functionality may also act as a first line of defense against server denial-of-service attacks.

The backend server 218 may be configured to operate as a gateway between the network 161 and the internal application management infrastructure. In an example, the internal application management infrastructure may be managed by a manufacturer of the vehicles 131, while in another example the internal application management infrastructure may be managed by another party, such as an application certification entity. The backend server 218 may be configured to perform as a firewall to validate, transform, and route messages between systems behind the backend server 218 (such as the key management server 220 and application remote management system 222) and vehicles 131 outside the internal application management infrastructure.

The key management system 220 may be configured to provide secure messaging services for messages to and from the backend server 218. For example, the key management system 220 may authenticate, decrypt and validate incoming messages, forward the decrypted and validated message to the proper internal destination, and provide outbound message security to encrypt and sign outgoing data and ensure that the outgoing messages pass security checks when they are received by the VCS 100 of the intended vehicle 131. In an example, the key management system 220 may validate messages against replay attacks by assigning message identifiers to outgoing messages, and verifying that appropriate message identifiers are included in incoming messages.

When a message or request is received by the backend server 218, the backend server 218 forwards the message to the key management system 220, where it is authenticated, decrypted, and validated. If these operations are successful, the backend server 218 may retrieve the message payload from the message and route the message to an appropriate application according to a service type identified by the message. In an example, policy table messages (e.g., requests for policy table updates 214) may be associated with a service type indicating that the messages are to be routed to the application remote management system 222.

The application remote management system 222 may be configured to receive application usage updates 216 from the vehicle 131, as well as provide policy table updates 214 to the vehicle 131. In an example, the application remote management system 222 may receive a snapshot of a local policy table 206 of the vehicle 131 in an application usage update 216 message. The local policy table 206 may include recorded application usage 208 for mobile applications 202 having interacted with the vehicle 131. The application remote management system 222 may archive the recorded application usage 208 from the received local policy table 206 and may update the application permissions stored by the vehicle 131 by providing the vehicle 131 with a policy table update 214. The policy table update 214 may be based on latest information maintained by the application remote management system 222 in a master policy table 224 of the latest mobile application 202 permissions. In an example, each version of a mobile application 202 (e.g. version 2 vs. version 2.1) may be associated with its own permission information in the master policy table 224. Notably, the master policy table 224 information provided in the policy table update 214 to the vehicle 131 may lack any recorded application usage 208 data, but may include up-to-date permissions for any mobile applications 202 that were identified as being used by the vehicle 131 according to the received local policy table 206 of the application usage update 216.

The application remote management system 222 may be further configured to provide an interface through which the master policy table 224 may be maintained. In an example, the master policy table 224 may be updated according to user input received from a connected application administrator considering third-party requests, customer feedback and other factors to set policies on a mobile application 202 by mobile application 202 basis.

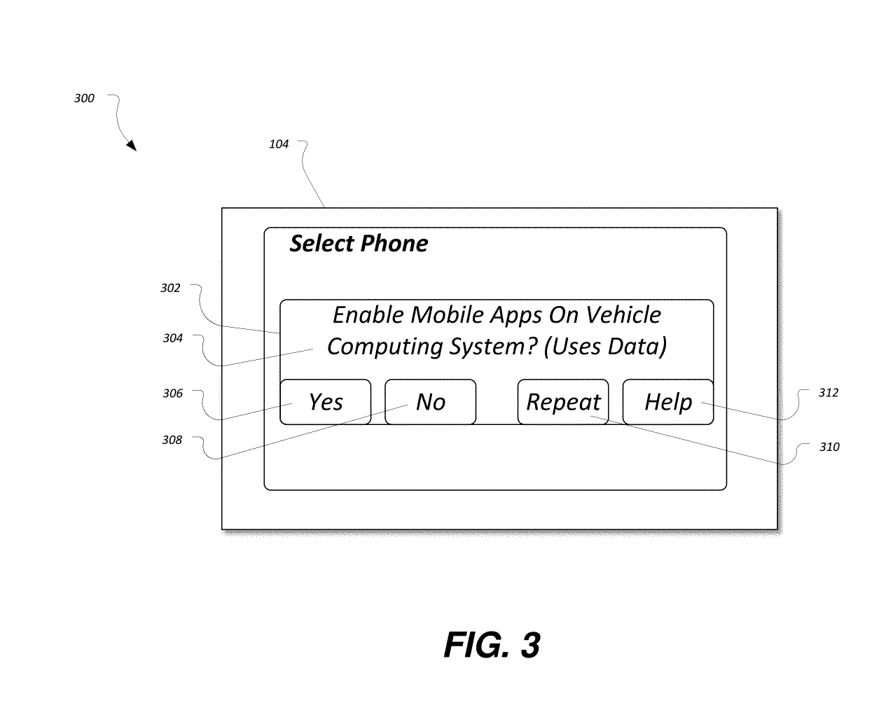

FIG. 3 illustrates an example user interface 300 of the VCS 100 from which approval to utilize mobile applications 202 may be selected. In an example, the user interface 300 may be displayed in the display 104 of the VCS 100. The user interface 300 may include a message prompt 302 configured to receive user consent to utilize mobile application 202 features via the VCS 100. The message prompt 302 may be provided, as some examples, when a user first pairs a nomadic device 153 with the VCS 100, or when a vehicle 131 determines that a user is attempting to use a mobile application 202 but consent has not been received.

The message prompt 302 may include application consent text 304 indicating to the user that the message prompt 302 is requesting the user to enable mobile application 202 functionality. The message prompt 302 may also provide information regarding the request by voice responsive via the audio functionality of the HMI of the VCS 100 (e.g., via speaker 113). The voice information may indicate that to use mobile applications 202 with the VCS 100, the VCS 100 will communicate with the backend server 218 (e.g., at least once per month) using the data plan of the user's nomadic device 153, and that standard data rates may apply for those communications. The voice information may also indicate that the VCS 100 may send information identifying the vehicle 131, such as VIN or VCS 100 module number to the backend server 218.

The message prompt 302 may receive user consent by way of the user speaking a voice command (e.g., “yes”) or by way of the user selecting a consent control 306 of the message prompt 302. The message prompt 302 may also receive an indication of no consent by way of the user speaking a voice command (e.g., “no”) or by way of the user selecting a no consent control 308 of the message prompt 302. The message prompt 302 may also include a repeat control 310 that, when selected, is configured to cause the message prompt 302 to repeat the voice information explaining the message prompt 302.

The message prompt 302 may also include a help control 312 that, when selected, is configured to provide additional information to the user regarding the consent. In an example, the additional information may include that update are about the size of an email, and the occurrence of policy table updates 214 depends on vehicle 131 usage and when a new mobile application 202 is found on the nomadic device 153. The additional information may further indicate that the user may turn mobile application 202 support on and off within the mobile applications 202 settings of the VCS 100.

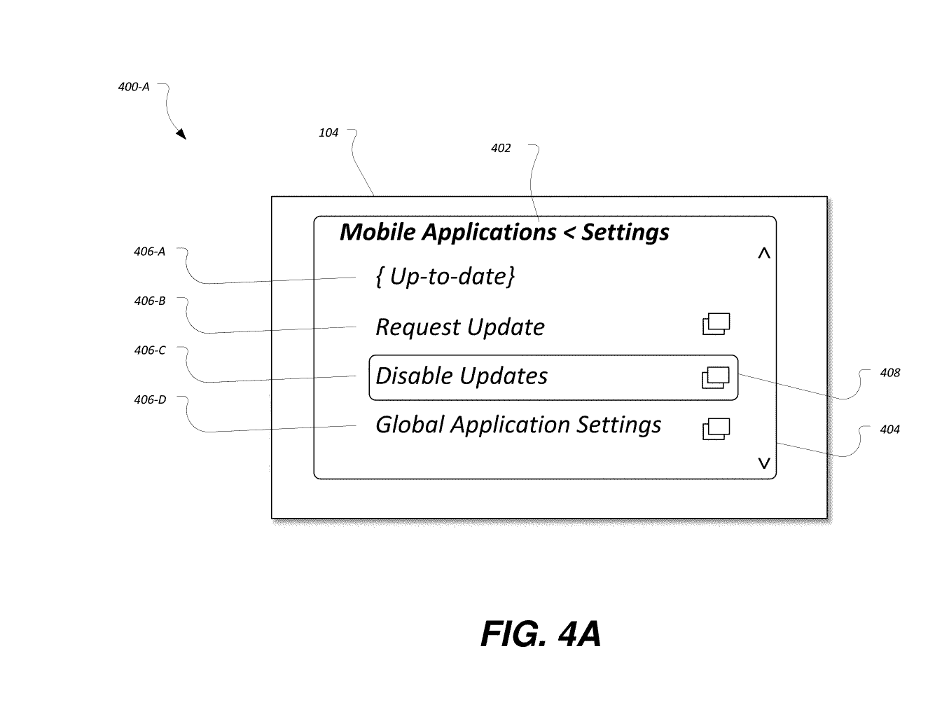

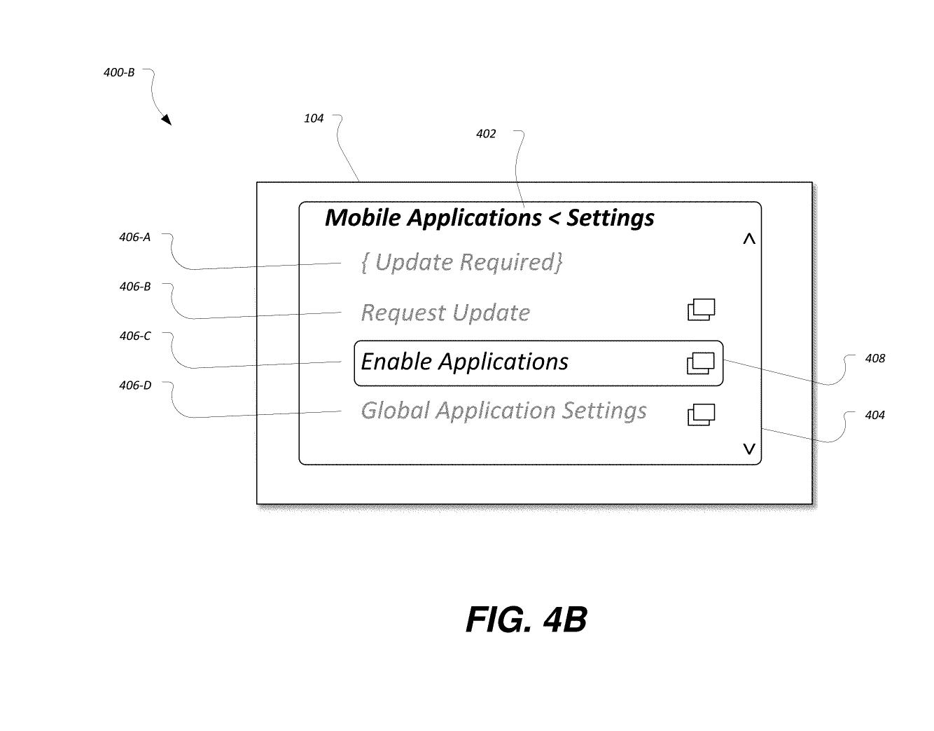

FIG. 4A illustrates an example user interface 400-A of the VCS 100 from which mobile application 202 settings may be configured. In an example, the user interface 400-A may be displayed in the display 104 of the VCS 100 responsive to user selection to configure mobile applications 202 settings of the VCS 100. The user interface 400-A may include a title label 402 to indicate to the user that the user interface 400-A is for mobile application 202 configuration.

The user interface 400-A may further include a list control 404 configured to display entries 406 indicative of the available configuration options of the user interface 400-A. The list control 404 may operate as a menu, such that a user of the user interface 400-A may be able to scroll through list entries of the list control 404 (e.g., using up and down arrow buttons and a select button to invoke the selected menu item 408). In some cases, the list control 404 may be displayed on a touch screen display 104, such that the user may be able to touch the list control 404 to select and invoke a menu item.

As illustrated, the list control 404 of the connected application includes an entry 406-A to indicate whether the local policy table 206 is up to date; an entry 406-B that, when selected, allows a user to request an updated local policy table 206; an entry 406-C that, when selected, allows a user to disable updating of the local policy table 206; and an entry 406-D that, when selected, allows a user to view other mobile application 202 settings.

FIG. 4B illustrates an alternate view of an example user interface 400-B of the VCS 100 from which mobile application 202 settings may be configured. In the illustrated user interface 400-B, a user has previously disabled updating of the local policy table 206 (e.g., due to selecting the entry 406-C from the user interface 400-A). As updating of the local policy table 206 is disabled, the other functions of the list control 404 have accordingly been disabled. If the user wishes to enable updating of the local policy table 206, the user may select the entry 406-C from the user interface 400-B, and then, for example, may select the entry 406-B to retrieve an updated local policy table 206.

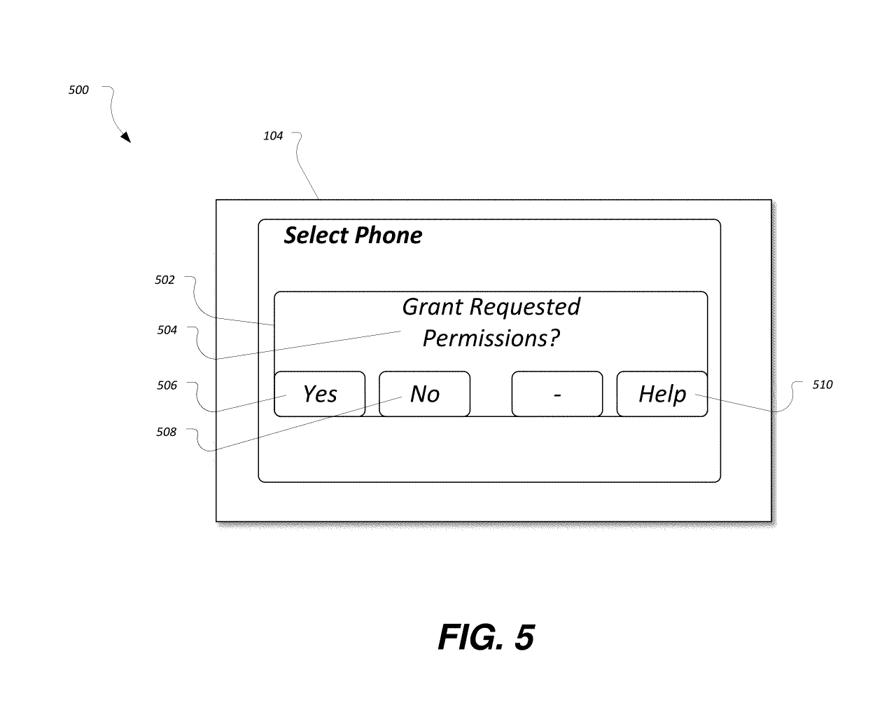

FIG. 5 illustrates an example user interface 500 of the VCS 100 for granting permissions specified by the local policy table 206 to a mobile application 202. The user interface 500 may include an application message prompt 502 configured to indicate that the user interface 500 is requesting to grant permissions to an invoked mobile application 202. In an example, the user interface 500 may be displayed in the display 104 of the VCS 100 the first time a user starts a mobile application 202 after a policy table update 214 is received from the backend server 218.

The application message prompt 502 may include application consent text 304 indicating to the user that the application message prompt 502 is requesting the user to enable the permissions specified for the mobile application 202 in the local policy table 206. The application message prompt 502 may also provide information regarding the request by voice responsive via the audio functionality of the HMI of the VCS 100 (e.g., via speaker 113). The voice information may identify the mobile application 202 requesting permission (e.g., by a name of the mobile application 202) and the permissions indicated by the local policy table 206 as being required (e.g., basic vehicle information, vehicle 131 location and speed, etc.). The voice information may also indicate that by granting the requested permissions to the mobile application 202, the user accepts liability for the loss of privacy for that data being made available.

The application message prompt 502 may receive user consent by way of the user speaking a voice command (e.g., “yes”) or by way of the user selecting a consent control 506 of the application message prompt 502. The application message prompt 502 may also receive an indication of no consent by way of the user speaking a voice command (e.g., “no”) or by way of the user selecting a no consent control 508 of the application message prompt 502. The application message prompt 502 may also include a help control 510 that, when selected, is configured to provide additional information to the user regarding the permission grant. In an example, the additional information may indicate that user adjust the permissions for mobile application 202 within the mobile applications 202 settings of the VCS 100.

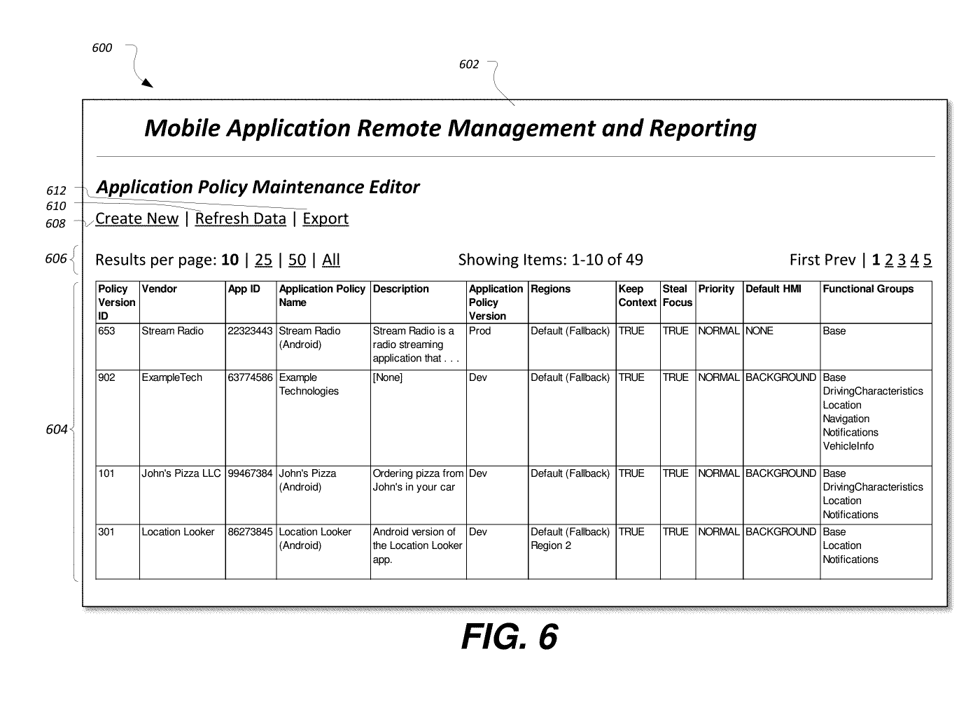

FIG. 6 illustrates an example user interface 600 of an application remote management system 222. In an example, the user interface 600 may be displayed by a terminal in communication with the application remote management system 222 (e.g., by a web browser in communication with a web server of the application remote management system 222). The user interface 600 may further include information useful for viewing and editing the master policy table 224 of the latest mobile application 202 permissions.

The user interface 600 may include a title 602 indicating that the user interface 600 is for the application remote management system 222. The user interface 600 may further include controls configured to allow an administrative user to input application information and define functionality and other operation of the system 100. For instance, the user interface 600 may include a policy table view control 604 configured to display entries of the master policy table 224 for viewing and editing by the user. Each entry may signify the permissions for a mobile application 202 (or for a version of a mobile application 202). For each entry, the policy table view control 604 may include information such as an identifier of the policy table entry, a vendor of the associated mobile application 202, the application identifier 204 of the associated mobile application 202, a name of the mobile application 202, a description of the mobile application 202, whether the mobile application 202 information is for a production or a development version of the mobile application 202, one or more regions in which the permissions for the mobile application 202 are applicable, and permission information with respect to what APIs, RPCs, and vehicle 131 systems are accessible for the mobile application 202. These permissions may include, as some possibilities, whether the mobile application 202 has permission to provide informational messages above other mobile applications 202, whether the mobile application 202 may be able to access HMI features when in the background or only when the foreground application, and a listing of one or more sets of information that the mobile application 202 may be able to access (e.g., the location of the vehicle 131, information regarding driver pedal input to the vehicle 131, etc.).

The user interface 600 may further include one or more view controls 606 configured to allow the user to sort, view and filter the permission entries listed in the policy table view control 604. The user interface 600 may further include a create new control 608 that, when selected, allows a user to add a new entry to the master policy table 224. As another example, the user interface 600 may further include a refresh data control 610 that, when selected, allows the user to receive an updated version of the master policy table 224 from the application remote management system 222 (e.g., to receive changes if another user has made edits). As a further example, the user interface 600 may include an export control 612 that when selected, allows the user to export master policy table 224 information from the application remote management system 222 (e.g., via a text file or spreadsheet file for download).

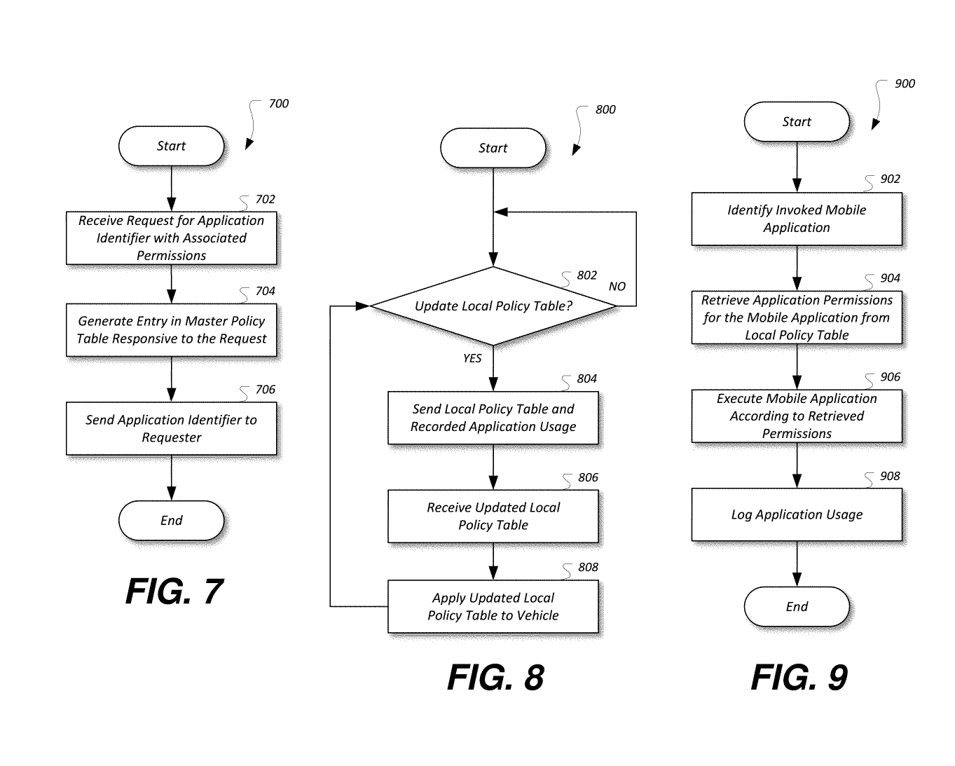

FIG. 7 illustrates an example process 700 for updating a master policy table 224. The process 700 may be performed, for example, by a user of the application remote management system 222.

At operation 702, the application remote management system 222 receives a request for an application identifier 204 for a mobile application 202. The request may further include additional information, such as permissions being requested for use by the mobile application 202, a category in which the mobile application 202 should be placed, and a vendor of the mobile application 202.

At operation 704, the application remote management system 222 generates an entry in the master policy table 224 responsive to the request. The generated entry may indicate the requested permissions and other information, and may further specify an application identifier 204 to be associated with the mobile application 202. In some examples, the application identifier 204 may be a randomly or incrementally generated value (e.g., next available number or sequence identifier).

At operation 706, the application remote management system 222 sends the application identifier 204 to the requester. For example, the application remote management system 222 may generate an application identifier 204 associated with the information received at operation 702, and may provide the generated application identifier 204 to the application developer for association with the mobile application 202. After operation 706 the process 700 ends.

FIG. 8 illustrates an example process 800 for updating a local policy table 206 of the vehicle 131. The process 800 may be performed, for example, by the policies manager 210 of the VCS 100.

At operation 802, the VCS 100 determines whether an update to the local policy table 206 is indicated. In an example, the VCS 100 may determine that the local policy table 206 should be updated due to the VCS 100 identifying that an application identifier 204 of a mobile application 202 app is not listed on the local policy table 206. In another example, the VCS 100 may determine that the local policy table 206 should be updated when the user starts a mobile application 202 that requires a local policy table 206 update and the policies manager 210 has not received an updated local policy table 206 over the initial request sequence. In yet further examples, the VCS 100 may determine that the local policy table 206 should be updated after one or more of: ‘N’ ignition cycles (e.g., where ‘N’ is defined within the local policy table 206), after ‘M’ kilometers have been recorded on the vehicle 131 odometer (e.g., where ‘M’ is defined within the local policy table 206), after ‘O’ elapsed time e.g., where ‘O’ is defined within the local policy table 206).

At operation 804, the VCS 100 sends an application usage update 216 message to the application remote management system 222. The application usage update 216 may include the current local policy table 206, and may be sent to an address according to address information included in the local policy table 206 (e.g., an update server URL). The application usage update 216 or the current local policy table 206 may further include the recorded application usage 208. The application usage update 216 may be sent to the application remote management system 222 via the backend server 218, and may be associated with a service type indicating that the message is to be routed to the application remote management system 222.

At operation 806, the VCS 100 receives a policy table update 214 message from the backend server 218. The policy table update 214 may include a new local policy table 206 to augment or replace the current local policy table 206 of the vehicle 131. The updated local policy table 206 may include the latest application permissions for the mobile applications 202 included in the local policy table 206 sent to the backend server. The new local policy table 206 may however, not include any recorded application usage 208.

At operation 808, the VCS 100 applies the updated local policy table 206. Accordingly, the updated application permission may be made available for use. After operation 808, the process 800 returns to operation 802.

FIG. 9 illustrates an example process 900 for using a local policy table 206 for permission control for mobile applications 202. As with the process 800, the process 900 may be performed, for example, by the policies manager 210 of the VCS 100.

At operation 902, the VCS 100 identifies an invoked mobile application 202. For example, the VCS 100 may receive a listing of applications identifiers 204 of mobile applications 202 available on the nomadic device 153. As another example, the VCS 100 may receive an indication of initiation of a mobile application 202 on the nomadic device 153.

At operation 904, the VCS 100 retrieves application permissions for the mobile application 202 from the local policy table 206. In an example, the VCS 100 may query the local policy table 206 for application permissions associated with the application identifier 204 of the mobile application 202. In another example, the VCS 100 may query the local policy table 206 for application permissions associated with the paired nomadic device 153 executing the mobile application 202 as well as the application identifier 204 of the mobile application 202. In some cases, if use of the mobile application 202 has not yet been consented to by the user, the VCS 100 may display a user interface for granting permission to use the mobile application 202, such as the user interface 500 discussed in detail above.

At operation 906, the VCS 100 executes the mobile application 202 according to the retrieved permissions. The VCS 100 may accordingly provide the mobile application 202 with access to vehicle 131 systems such as available features and HMI, in accordance with the application permissions associated with the mobile application 202 and, in some examples, further according to the nomadic device 153.

At operation 908, the VCS 100 logs application usage of the mobile application 202. For example, the VCS 100 may record application usage 208 including usage of APIs, RPCs and vehicle 131 systems by the mobile applications 202. After operation 908, the process 900 ends.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A system comprising:
a memory storing a local policy table; and
a processor device of a vehicle configured to
identify an application identifier of a mobile application executed by a mobile device paired with the vehicle and a mobile device identifier of the mobile device;
query the local policy table for application permissions associated with the application identifier and the mobile device identifier, the application permissions defining which user interface features, vehicle information elements, and vehicle functions are accessible to the mobile application; and
provide the mobile application with mobile device-specific vehicle access in accordance with the application permissions.

2. (canceled)

3. The system of claim 1, wherein the processor is further configured to:
identify that the local policy table lacks application permissions associated with the application identifier; and
send an application usage update message to the mobile device configured to cause the mobile device to request a policy table update from a remote server.

4. The system of claim 3, wherein the application usage update message includes the local policy table.

5. The system of claim 4, wherein the local policy table includes recorded application usage indicative of mobile application use of the user interface features, information elements, and functions of the vehicle.

6. The system of claim 1, wherein the local policy table includes an indication of a geographic region within which the application permissions are valid, and the processor is configured to utilize the application permissions when the vehicle is within the geographic region.

7. The system of claim 1, wherein the processor is further configured to:
capture application usage related to the usage of the mobile application; and
record the application usage in the local policy table.

8. The system of claim 1, wherein the processor is further configured to terminate the mobile application responsive to the mobile application attempting to utilize a function of the vehicle for which, according to the local policy table, the mobile application lacks permission.

9. The system of claim 1, wherein the processor is further configured to, responsive to occurrence of at least one of a predetermined period of time, a predetermined number of key cycles, and a predetermined increase in vehicle odometer distance since the local policy table was updated, send an application usage update message to the mobile device configured to cause the mobile device to request a policy table update from a remote server.

10. A system comprising:
a mobile device paired with a vehicle and configured to
send, to a vehicle, a policy table update received from a server and including a local policy table including application permissions specific to a unique identifier of the device and defining which user interface features, information elements, and functions of the vehicle are accessible to a mobile application; and
execute the mobile application in accordance with the application permissions for the device.

11. The system of claim 10, wherein the mobile device is further configured to:
receive an application usage update message from the vehicle; and
forward the application usage update message to the server to cause the server to send the policy table update to the mobile device.

12. The system of claim 11, wherein the application usage update message includes the local policy table.

13. The system of claim 10, wherein the local policy table includes recorded application usage indicative of mobile application use of the user interface features, information elements, and functions of the vehicle.

14. The system of claim 10, wherein the policy table update received from the server includes application permissions associated with a geographic region, and the mobile device is configured to utilize the application permissions when the vehicle is within the geographic region.

15. A system comprising:
an application remote management server including a processing device configured to:
receive, from a vehicle, an application usage update message including a local policy table having application identifiers of mobile applications available to the vehicle from a paired mobile device; and
send, to the vehicle, a local policy table including application permissions specific to the mobile device and defining which user interface features, information elements, and functions of the vehicle are accessible to the mobile applications.

16. The system of claim 15, wherein the application remote management server is further configured to access a master policy table including a current listing of application permissions indexed according to application identifiers to retrieve the application permissions associated with the application identifiers.

17. The system of claim 16, wherein the application remote management server is further configured to:
receive a request from a requester for a new application identifier including new application permissions defining which user interface features, information elements, and functions of the vehicle are accessible to the mobile application for which an application identifier is requested; and
generate an entry in the master policy table including the new application permissions according to the new application identifier.

18. The system of claim 17, wherein the application remote management server is further configured to send the new application identifier to the requester responsive to the request.

19. The system of claim 15, wherein the local policy table includes application permissions associated with a plurality of geographic regions.

20. The system of claim 15, wherein the application usage update message includes an indication of a version of a mobile application, and the local policy table includes application permissions associated with the version of a mobile application.

21. The system of claim 1, wherein the local policy table further includes application-independent permissions associated with the mobile device identifier regardless of application identifier, and the processor device is further configured to provide the mobile application with mobile device-specific vehicle access in accordance with the application permissions and the application-independent permissions.
